(19) United States
(12) Patent Application Publication
(10) Pub. No.: US 2026/0246069 A1
(43) Pub. Date: Aug. 20, 2026

(54) BATTERY PACK WITH THERMAL RUNAWAY CONTAINMENT

(71) Applicant: BETA AIR LLC, South Burlington, VT (US)

(72) Inventors: Nathan Goldsberry, Winooski, VT (US); Sam Wagner, Westford, VT (US); Sean Donovan, Richmond, VT (US); Jeff Goldman, Williston, VT (US); Stuart Schreiber, Essex, VT (US); Sarah Overfield, Colchester, VT (US); Braedon Lohe, Essex Junction, VT (US)

(21) Appl. No.: 19/058,510

(22) Filed: Feb. 20, 2025

(51) Int. Cl. H01M 50/367; H01M 50/204; H01M 50/249; H01M 50/342

(52) U.S. Cl. CPC H01M 50/367; H01M 50/249; H01M 50/3425; H01M 50/204; H01M 2200/20

(57) ABSTRACT

A battery pack including measures to contain thermal runaway and mitigate damage therefrom. Battery subpacks are arranged with vent ends with vents/burst plates at a pack vent manifold of the battery pack. If a subpack cell enters thermal runaway, the battery subpack burst plate ruptures and ejecta enters the pack vent manifold and exits via an exhaust port. Leaks from coolant are prevented from contaminating electrical and data connections by placing fluid connectors and piping in the pack vent manifold with electrical and data connections at the opposite ends of the battery subpacks.

### BACKGROUND OF THE INVENTION

The disclosure relates generally to electric vehicle safety measures, and more particularly to battery cell thermal runaway safety measures.

In electric vehicle batteries, measures must be provided to handle the effects of thermal runaway of one or more cells of a battery of the electric vehicle. In ground-and water-based vehicles, thermal insulation of various types can be included with little consideration of the weight of such materials. However, weight is a high priority consideration for electric aircraft. Thus, thermal runaway measures for electric aircraft must use lighter materials and/or employ techniques to reduce weight than ground-and water-based vehicles.

### BRIEF DESCRIPTION OF THE INVENTION

All aspects, examples and features mentioned below can be combined in any technically possible way.

An aspect of the disclosure provides a battery pack comprising: a pack casing having a vent side wall, and a closed side wall opposite the vent side wall; a plurality of battery subpacks disposed in the pack casing, each battery subpack of the plurality of battery subpacks including an enclosure that is a pressure vessel until pressure within the enclosure exceeds a threshold pressure and with: a vent end proximate the vent side wall of the pack casing, wherein the vent end includes a subpack vent that opens when pressure within the enclosure of the battery subpack exceeds the threshold pressure; and a connector end opposite the vent end and proximate the closed side wall of the pack casing, wherein the connector end includes an electrical terminal; and a pack vent manifold defined between the vent side wall of the pack casing and the vent ends of the plurality of battery subpacks, wherein the pack vent manifold is in fluid communication with a pack exhaust outlet extending through the pack casing.

Another aspect of the disclosure includes any of the preceding aspects, and further comprising an explosive fire zone (EFZ) defined by at least the pack exhaust outlet and the pack vent manifold, wherein the EFZ directs ejecta from a battery subpack of the plurality of battery subpacks away from the connector end, through the pack vent manifold, and out of the battery pack through the pack exhaust outlet.

Another aspect of the disclosure includes any of the preceding aspects, and wherein the EFZ further includes the vent ends of the battery subpacks.

Another aspect of the disclosure includes any of the preceding aspects, and wherein the EFZ further includes interiors of the battery subpack.

Another aspect of the disclosure includes any of the preceding aspects, and wherein the pack exhaust outlet is in fluid communication with an exterior of an electric vehicle in which the battery pack is installed.

Another aspect of the disclosure includes any of the preceding aspects, and wherein the pack exhaust outlet is configured for fluid communication with an exhaust outlet of an electric vehicle when the battery pack is installed therein.

An aspect of the disclosure provides a battery pack comprising: a pack casing having a vent side wall and a closed side wall opposite the vent side wall; a plurality of battery subpacks disposed in the pack casing, each including: a vent end proximate the vent side wall of the pack casing, wherein the vent end includes a fluid connector; and a connector end opposite the vent end and proximate the closed side wall of the pack casing, wherein the connector end includes an electrical terminal; a pack vent manifold defined between the vent side wall of the pack casing and the vent ends of the plurality of battery subpacks, wherein the pack vent manifold is in fluid communication with a pack exhaust outlet formed in and through the pack casing; a pack fluid connector formed in and through a wall of the pack casing; and a fluid conduit in the pack vent manifold that is in fluid communication with the pack fluid connector and the fluid connector of one of the battery subpacks.

Another aspect of the disclosure includes any of the preceding aspects, and wherein the pack fluid connector is configured for fluid communication with one of a vehicle fluid connection port or a fluid connector of another, substantially identical battery pack.

Another aspect of the disclosure includes any of the preceding aspects, and wherein the pack fluid connector is in parallel fluid communication with a respective fluid connector of each battery subpack of the plurality of battery subpacks via respective fluid conduits in the pack vent manifold.

Another aspect of the disclosure includes any of the preceding aspects, and wherein for each battery subpack of the plurality of battery subpacks, the respective fluid connector is a first fluid connector and each battery subpack further includes a second fluid connector, the pack fluid connector is in fluid communication with the first fluid connector of a first battery subpack of the plurality of battery subpacks via a respective fluid conduit, and additional fluid conduits in the pack vent manifold fluidly connect the fluid connectors of the plurality of battery subpacks in series starting with the second fluid connector of the first battery subpack.

Another aspect of the disclosure includes any of the preceding aspects, and wherein the pack fluid connector is a first pack fluid connector, a second pack fluid connector extends through a second wall of the pack casing and is in fluid communication with a respective fluid connector of at least one battery subpack of the plurality of battery subpacks via a respective fluid conduit in the pack vent manifold.

Another aspect of the disclosure includes any of the preceding aspects, and wherein for each battery subpack the respective fluid connector is a first fluid connector and each battery subpack further includes a second fluid connector, the first pack fluid connector is in parallel fluid communication with the first fluid connector of each battery subpack of the plurality of battery subpacks via respective fluid conduits in the pack vent manifold, and the second pack fluid connector is in parallel fluid communication with the second fluid connector of each battery subpack of the plurality of battery subpacks.

Another aspect of the disclosure includes any of the preceding aspects, and wherein for each battery subpack of the plurality of battery subpacks the respective fluid connector is a first fluid connector and each battery subpack further includes a second fluid connector, the first pack fluid connector is in fluid communication with the first fluid connector of a first battery subpack of the plurality of battery subpacks via the respective fluid conduit, the second pack fluid connector is in fluid communication with the second fluid connector of a last battery subpack of the plurality of battery subpacks, and additional fluid conduits in the pack vent manifold fluidly connect the fluid connectors of the plurality of battery subpacks in series starting with the second fluid connector of the first battery subpack and ending with the first fluid connector of the last battery subpack.

Another aspect of the disclosure includes any of the preceding aspects, and wherein the second pack fluid connector is configured for fluid communication with one of a first pack fluid connector of another, substantially identical battery pack or the vehicle fluid connection port.

An aspect of the disclosure provides a battery pack comprising: a pack casing having a vent side wall, and a closed side wall opposite the vent side wall; a plurality of battery subpacks disposed in the pack casing, each battery subpack of the plurality of battery subpacks including an enclosure that is a pressure vessel until pressure within the enclosure exceeds a threshold pressure and with: a vent end proximate the vent side wall of the pack casing, wherein the vent end includes a fluid connector and a vent that opens when pressure within the enclosure of the battery subpack exceeds the threshold pressure; and a connector end opposite the vent end and proximate the closed side wall of the pack casing, wherein the connector end includes an electrical terminal; a pack vent manifold defined between the vent side wall of the pack casing and the vent ends of the plurality of battery subpacks, wherein the pack vent manifold is in fluid communication with a pack exhaust outlet formed in and through the pack casing and; a fluid conduit in the pack vent manifold that extends from a pack fluid connector to a fluid connector of at least one battery subpack of the plurality of battery subpacks.

Another aspect of the disclosure includes any of the preceding aspects, and further comprising an explosive fire zone (EFZ) defined by at least the pack exhaust outlet and the pack vent manifold, wherein the EFZ directs ejecta from a battery subpack of the plurality of battery subpacks away from the connector end, through the pack vent manifold, and out of the battery pack through the pack exhaust outlet.

Another aspect of the disclosure includes any of the preceding aspects, and wherein the EFZ further includes the vent ends of the battery subpacks.

Another aspect of the disclosure includes any of the preceding aspects, and wherein the pack fluid connector is a first pack fluid connector, the fluid connector of each battery subpack is a respective first fluid connector in parallel fluid communication with the first pack fluid connector via a respective fluid conduit in the pack vent manifold, and each battery subpack includes a second fluid connector in parallel fluid communication with a second pack fluid connector via additional fluid conduits in the pack vent manifold.

Another aspect of the disclosure includes any of the preceding aspects, and wherein the pack fluid connector is a first pack fluid connector, the fluid connector of each battery subpack is a respective first fluid connector, the first pack fluid connector is in fluid communication with the first fluid connector of a first battery subpack via a respective fluid conduit in the pack vent manifold, each battery subpack includes a second fluid connector, the fluid connectors of the battery subpacks are fluidly connected in series via additional fluid conduits in the pack vent manifold beginning with the second fluid connector of the first battery subpack and ending with the first fluid connector of a last battery subpack.

Another aspect of the disclosure includes any of the preceding aspects, and wherein the second fluid connector of the last battery subpack is in fluid communication with a second pack fluid connector via a respective fluid conduit in the pack vent manifold.

Two or more aspects described in this disclosure, including those described in this summary section, may be combined to form implementations not specifically described herein.

The details of one or more implementations are set forth in the accompanying drawings and the description below. Other features, objects and advantages will be apparent from the description and drawings, and from the claims.

### BRIEF DESCRIPTION OF THE DRAWINGS

These and other features of this disclosure will be more readily understood from the following detailed description of the various aspects of the disclosure taken in conjunction with the accompanying drawings that depict various embodiments of the disclosure, in which:

FIG. 1 is a view of a vent manifold side of a battery pack according to aspects of the disclosure;

FIG. 2 is a cutaway view of a battery pack according to aspects of the disclosure perpendicular to the vent manifold side thereof;

FIG. 3 is a top view of the battery pack of FIG. 1 with a top wall thereof removed;

FIG. 4 is a view of a closed side of a battery pack according to aspects of the disclosure with the side and top walls removed;

FIG. 5 is a view of the underside of an electric vehicle, here an aircraft, employing battery packs according to aspects of the disclosure; and

FIG. 6 is a series of views of a heat exchange device used in battery subpacks of a battery pack according to aspects of the disclosure illustrating a relationship between the heat exchange device and a battery subpack in which it can be used.

It is noted that the drawings of the disclosure are not necessarily to scale. The drawings are intended to depict only typical aspects of the disclosure and therefore should not be considered as limiting the scope of the disclosure. In the drawings, like numbering represents like elements between the drawings.

### DETAILED DESCRIPTION

As an initial matter, in order to clearly describe the current disclosure, it will become necessary to select certain terminology when referring to and describing relevant machine components within the illustrative application of a battery subpack and cell array therefor. When doing this, if possible, common industry terminology will be used and employed in a manner consistent with its accepted meaning. Unless otherwise stated, such terminology should be given a broad interpretation consistent with the context of the present application and the scope of the appended claims. Those of ordinary skill in the art will appreciate that often a particular component may be referred to using several different or overlapping terms. What may be described herein as being a single part may include and be referenced in another context as consisting of multiple components. Alternatively, what may be described herein as including multiple components may be referred to elsewhere as a single part. It should be understood that embodiments disclosed herein may be described in the context of and or implementation in electric aircraft, but could also be implemented in other electric vehicles as suitable and/or desired. That said, embodiments as disclosed herein include features that can particularly enhance desirability for use in aircraft, such as the use of alternative materials, structures, and/or methods resulting in reduced vehicle weight and/or enhanced aircraft safety.

In addition, several descriptive terms may be used regularly herein, and it should prove helpful to define these terms at the onset of this section. These terms and their definitions, unless stated otherwise, are as follows. As used herein, “downstream” and “upstream” are terms that indicate a direction relative to the flow of a fluid, such as a coolant employed during operation of an electric vehicle using embodiments of the disclosure or, for example, the flow of air through and/or around an electric vehicle, such as an electric aircraft, in which embodiments of the disclosure are deployed. The term “downstream” corresponds to the direction of flow of the fluid, and the term “upstream” refers to the direction opposite to the flow. The terms “forward” and “aft,” without any further specificity, refer to directions, with “forward” or “fore” referring to the front or nose of an electric aircraft, and “aftward” or “aft” referring to the rearward or tail end of the aircraft.

The terminology used herein is for the purpose of describing particular embodiments only and is not intended to be limiting of the disclosure. As used herein, the singular forms “a,” “an,” and “the” are intended to include the plural forms as well, unless the context clearly indicates otherwise. In addition, several descriptive terms may be used regularly herein, as described below. The terms “first,” “second,” and “third,” may be used interchangeably to distinguish one component from another and are not intended to signify location or importance of the individual components. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. “Optional” or “optionally” means that the subsequently described event or circumstance may or may not occur or that the subsequently described component or element may or may not be present and that the description includes instances where the event occurs or the component is present and instances where the event does not occur or the component is not present.

Where an element or layer is referred to as being “on,” “engaged to,” “engaging,” “connected to,” “coupled to,” or “mounted to” another element or layer, it may be directly on, engaged, connected, coupled, or mounted to the other element or layer, or intervening elements or layers may be present. In contrast, when an element is referred to as being “directly on,” “directly engaged to,” “directly engaging,” “directly connected to,” or “directly coupled to” another element or layer, no intervening elements or layers are present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items. The verb forms of “couple,” “connect,” “attach,” and “mount” may be used interchangeably herein.

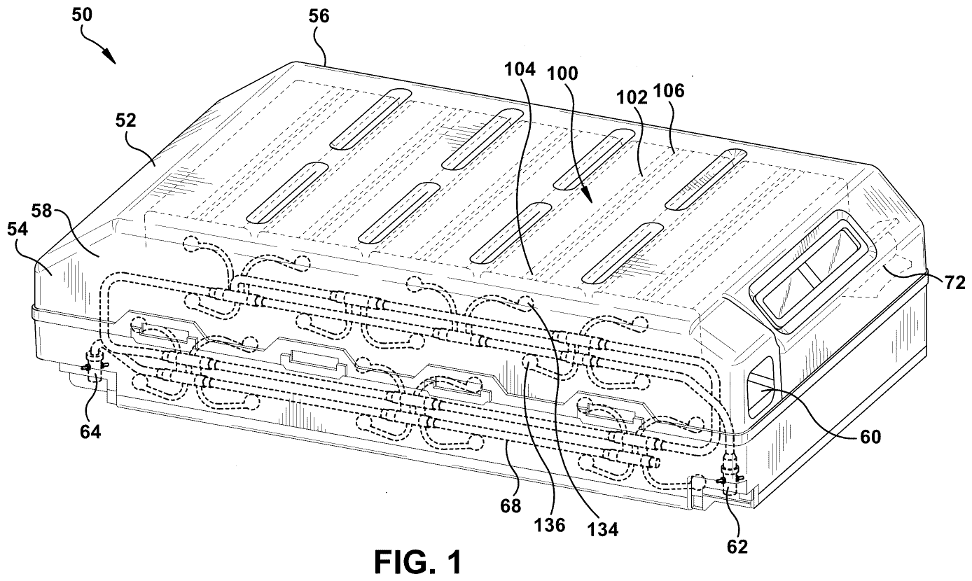

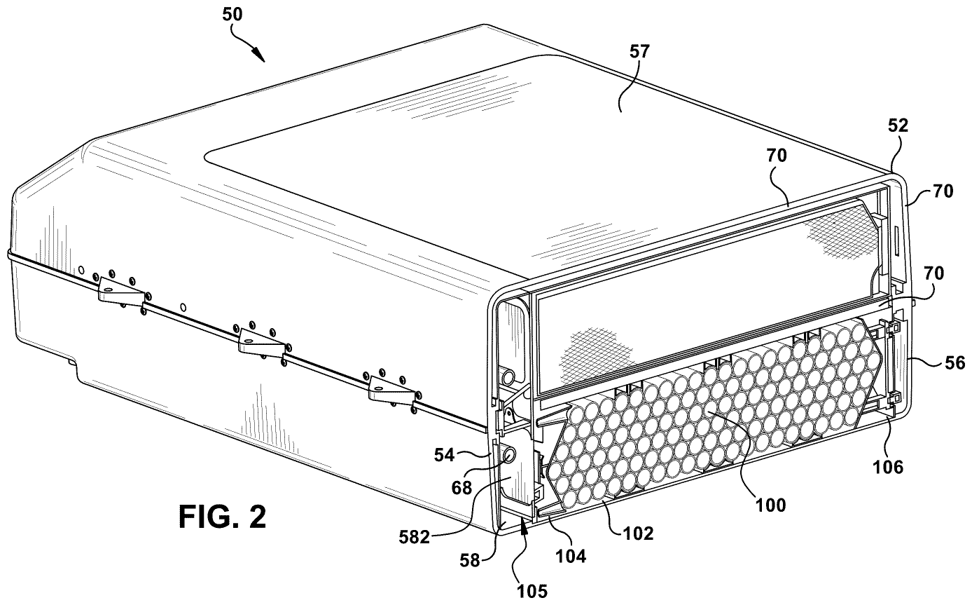

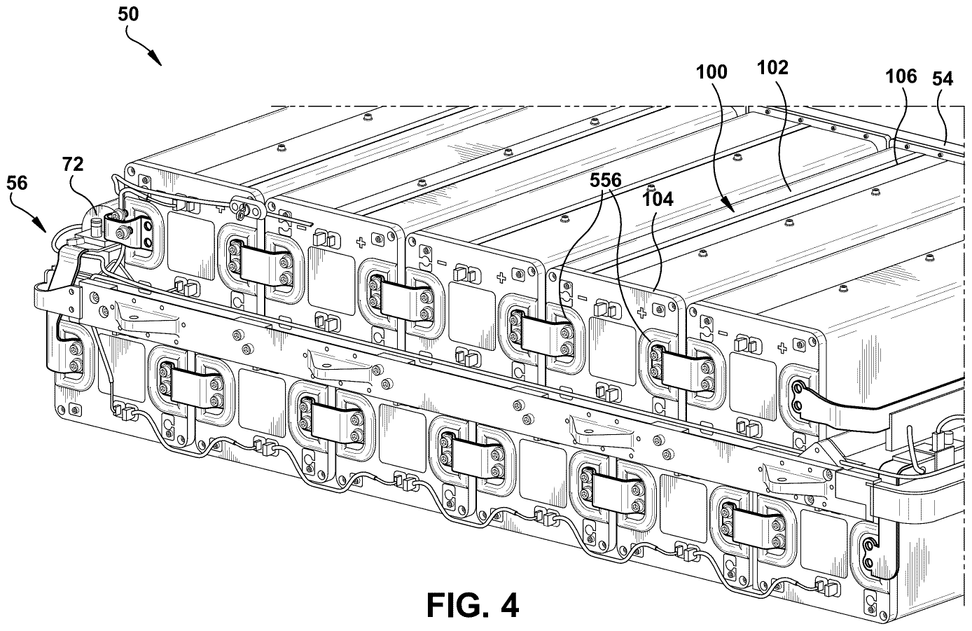

With reference to the accompanying drawings, and particularly FIG. 1, aspects of the invention provide a battery pack 50 including a plurality of battery subpacks 100 with like ends 104, 106 aligned in a pack casing 52. “Vent” ends 104 of battery subpacks 100 include a vent 105 (FIG. 2), such as a burst plate, while “connector” ends 106 of the battery subpacks 100 opposite the vent ends 104 include electrical and/or data connectors, such as an electrical terminal 556 (FIG. 4). The pack casing 52 includes a pack vent manifold 58 between a vent side wall 54 of pack casing 52 and the vent ends 104 of the battery subpacks 100, so that the side of the pack casing 52 with the pack vent manifold 58 can be said to be a vent side of pack casing 52 and pack 50 overall. Cabling for power/data is run through space on the opposite, “closed side” of pack casing 52, which can include a closed side wall 56. Fire detection and other components 72 can be provided on ends of pack casing 52 near the side walls of the outermost battery subpacks 100.

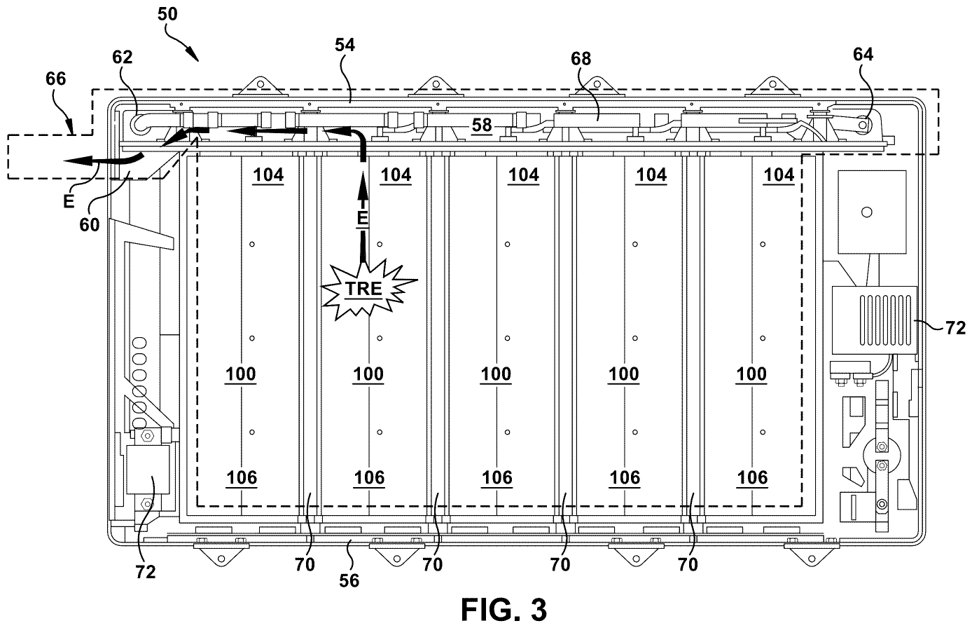

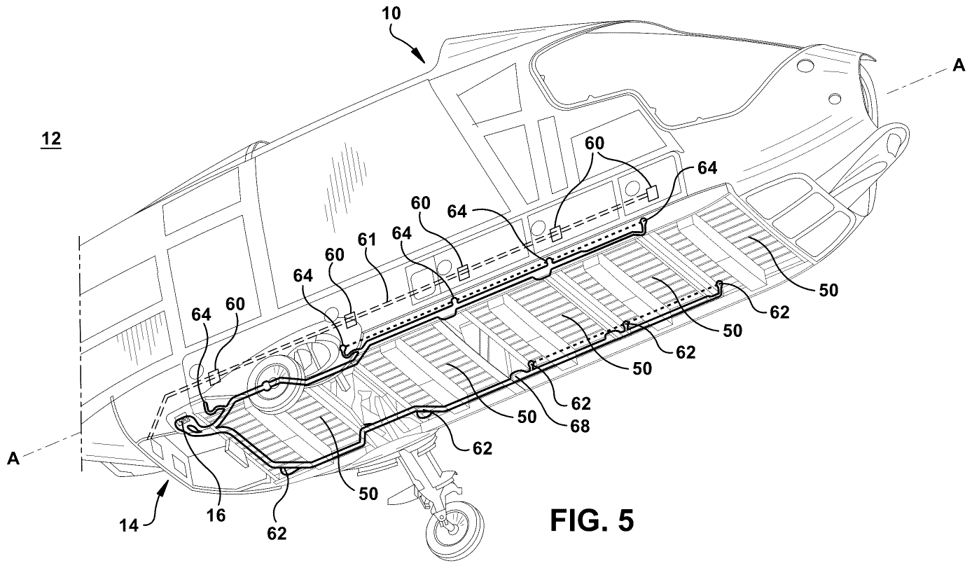

As illustrated in FIG. 3, during a thermal runaway event TRE of a battery subpack 100, if pressure exceeds the threshold pressure, the battery subpack vent 105 (FIG. 2) opens, such as a burst plate 582 deforming and detaching, to release ejecta from battery subpack 100 (FIG. 3). An enclosure 102 of each battery subpack 100 thus acts as a pressure vessel until pressure within enclosure 102 exceeds the threshold pressure of vent 105. The ejecta can include hot gas, liquid, component fragments, or other materials from battery subpack 100, which enters pack vent manifold 58 upon opening of vent 105 (FIG. 2), such as deformation/detachment of a burst plate. Ejecta E received in pack vent manifold 58 exits through a pack exhaust outlet 60 in battery pack casing 52. In embodiments, as shown in FIG. 5, pack exhaust outlet 60 can be in fluid communication with an exterior 12 of vehicle 10, such as an aircraft, to allow ejecta E to escape the vehicle. For example, an exhaust outlet 14 of electric vehicle 10 can be in fluid communication with each pack exhaust outlet 60 via an exhaust conduit 15 of electric vehicle 10.

Returning to FIG. 3, with continuing reference to FIGS. 1 and 2, the movement of ejecta E from a battery subpack 100 into pack vent manifold 58 and to and through exhaust outlet 60 is effected by an explosive flame zone (EFZ) 66 of battery pack 50. EFZ 66 can include interiors of battery subpacks 100, vent ends 104 and vents 105 (such as burst plates, FIG. 2) of battery subpacks 100, pack vent manifold 58, and pack exhaust outlet 60, also referred to as a pack vent. As noted above, each battery subpack 100 has an enclosure 102 that acts as a pressure-limited pressure vessel in which vent 105 opens when pressure within subpack enclosure 102 exceeds a threshold value. The electrical and data connections, such as terminals 556 (FIG. 4), are on connector ends 106 of battery subpacks 100, are therefore not in EFZ 66, and so are protected from exposure to ejecta E and the bulk of heat related to a thermal runaway event. EFZ 66 and supporting structure enables thermal runaway to be contained to the initial battery subpack 100 in which a thermal runaway event initially occurs. As particularly seen in FIGS. 2 and 3, insulation 70 between battery subpacks 100 (FIG. 2), between rows of battery subpacks 100 (FIG. 3), between pack casing 52 top wall 57 and the top row of battery subpacks 100 (FIG. 3), and/or between EFZ 66 and other areas additionally inhibit the spread of thermal runaway heat and/or ejecta, which further contains thermal runaway to the battery subpack 100 in which the thermal runaway event initially occurs.

In addition to vents 105 on vent ends 104 of battery subpacks 100, each battery subpack 100 also has fluid connectors 134, 136 on its vent end 104 that extend into pack vent manifold 58. Fluid conduits 68, such as tubing, connect battery subpack connectors 134, 136 to each other and to pack fluid connectors 62, 64 formed at one or both ends of pack 50 and are also disposed in pack vent manifold 58. As a result, should a fluid leak occur within pack casing 52, the fluid enters pack vent manifold 58, preventing fluid contact that could result in damage or destruction of the electrical and/or data connections at connector ends 106 of battery subpacks 100. In embodiments, leaked fluid can exit pack 50 through pack exhaust outlet 60, further preventing fluid contact that could result in damage or destruction of components at connector ends 106 of battery subpacks 100. In addition, as seen in FIG. 5, pack 50 is modular so that multiple packs 50 can be used to form a power source for an electric vehicle 10, such as an aircraft. For example, as shown in the example of FIG. 5, four or five packs 50 can be installed along the bottom of an electric vehicle 10, such as an aircraft and with their sides perpendicular to a fuselage central longitudinal axis A, the sides adjacent and/or engaging and with pack fluid connectors 62, 64 aligned. Where one pack fluid connector 62, 64 is provided at each end of packs 50, fluid inlet connectors 62 can be on one side of the fuselage and fluid outlet connectors 64 can be on the other side of the fuselage, allowing convenient fluid connection of packs 50 to their neighbors and to an aircraft fluid port 16. As also seen in FIG. 5, electric vehicle 10 can include a vehicle exhaust outlet 14 or exhaust conduit thereto, with which pack exhaust outlet(s) 60 can be in fluid communication.

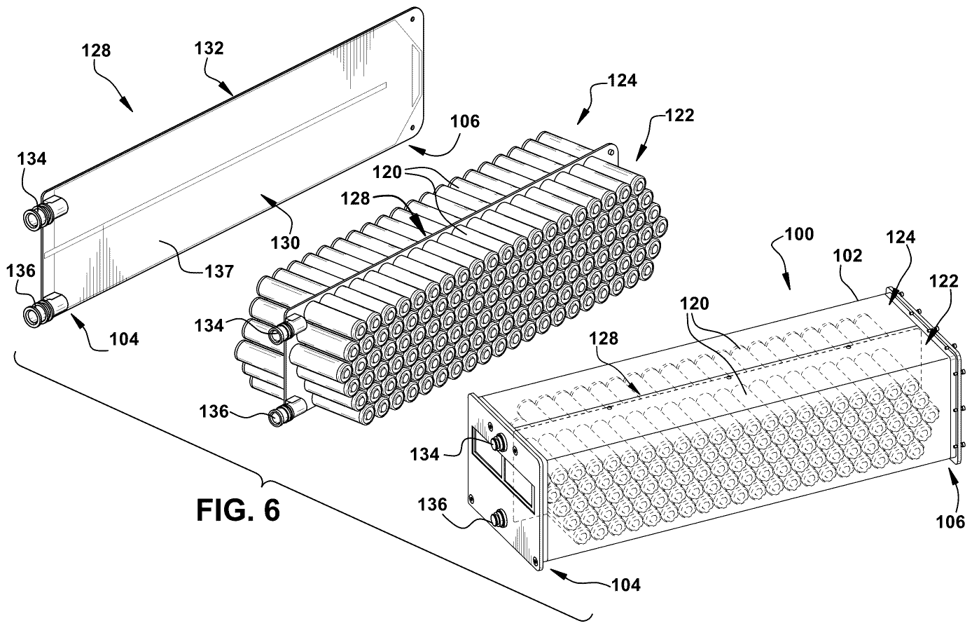

In embodiments, as seen in FIGS. 1 and 4, a battery subpack arrangement in pack casing 52 includes a bottom row of six battery subpacks 100 and a top row of five battery subpacks 100. The top battery subpacks 100 can be upside down relative to the bottom battery subpacks 100 to facilitate electrical connections (FIG. 4) without excessive customization or additional parts required. With additional reference to FIG. 6, upper and lower fluid connectors 134, 136 of each battery subpack 100 are part of a heat exchange device 128, such as a cold plate, within subpack enclosure 102. Heat exchange device 128 has a fluid passage 137 extending from one connector 134 at vent end 104 to connector end 106 and to the other connector 136 back at vent end 104. A first surface 130 of heat exchange device 128 can be in heat transfer communication with a first cluster 122 of battery cells 120, and a second surface 132 of heat exchange device 128 opposite from first surface 130 can be in heat transfer communication with a second cluster 124 of battery cells 120 so that heat can pass between the battery cells 120 and fluid circulating through fluid passage 137.

In some embodiments, upper fluid connectors 134 of battery subpacks 100 are connected in parallel to the pack fluid inlet connector 62, while the lower fluid connectors 136 of the battery subpacks 100 are connected in parallel to the pack fluid outlet connector 64. That is, a first fluid connector 134 of each battery subpack 100 is in parallel fluid communication with a first pack fluid connector 62 via a respective fluid conduit 68 in pack vent manifold 58, and a second fluid connector 136 of each battery subpack 100 is in parallel fluid communication with second pack fluid connector 64 via additional fluid conduits 68 in pack vent manifold 58.

In other embodiments, packs 50 can be connected in series. For example, first pack connector 62 can be in fluid communication with first fluid connector 134 of a first battery subpack 100 via a respective fluid conduit 68 in pack vent manifold 58, and the fluid connectors 134, 136 of battery subpacks 100 can be fluidly connected in series via additional fluid conduits 68 in pack vent manifold 58, beginning with second fluid connector 136 of the first battery subpack 100 and ending with first fluid connector 134 of a last battery subpack 100. The second fluid connector 136 of the last battery subpack 100 can be in fluid communication with second pack fluid connector 64 via a respective fluid conduit 68 in pack vent manifold 58.

By running fluid in at the top of each battery subpack 100 and out at the bottom, gravity assists with circulation and particularly with drainage of fluid from battery subpacks 100 and pack 50 as a whole. Further gravity assist in drainage of pack 50 is enabled by forming pack fluid connectors 62, 64, or at least pack outlet fluid connector 64, in the bottom of pack casing 52, such as at an end thereof.

Embodiments of the disclosure provide various technical and commercial advantages, examples of which are discussed herein. A technical effect of embodiments is the protection of electrical, data, and other heat sensitive components from excessive heat during a thermal runaway even of a battery pack. Another technical effect of embodiments is the protection of electrical, data, and other liquid sensitive components from exposure to fluid, such as a coolant used to cool battery subpacks of a battery pack, that may have been leaked due to failure of a hose, conduit, and/or connector.

Approximating language, as used herein throughout the specification and claims, may be applied to modify any quantitative representation that could permissibly vary without resulting in a change in the basic function to which it is related. Accordingly, a value modified by a term or terms, such as “about,” “approximately” and “substantially,” are not to be limited to the precise value specified. In at least some instances, the approximating language may correspond to the precision of an instrument for measuring the value. Here and throughout the specification and claims, range limitations may be combined and/or interchanged; such ranges are identified and include all the sub-ranges contained therein unless context or language indicates otherwise. “Approximately” or “about,” as applied to a particular value of a range, applies to both end values and, unless otherwise dependent on the precision of the instrument measuring the value, may indicate +/−10% of the stated value(s).

The corresponding structures, materials, acts, and equivalents of all means or step plus function elements in the claims below are intended to include any structure, material, or act for performing the function in combination with other claimed elements as specifically claimed. The description of the present disclosure has been presented for purposes of illustration and description but is not intended to be exhaustive or limited to the disclosure in the form disclosed. Many modifications and variations will be apparent to those of ordinary skill in the art without departing from the scope and spirit of the disclosure. The embodiments were chosen and described in order to best explain the principles of the disclosure and the practical application of such technology and to enable others of ordinary skill in the art to understand the various embodiments of the present disclosure and the possibility of various modifications of the disclosed embodiments, as may be suited to the particular use(s) contemplated.

While the invention has been described in detail in connection with only a limited number of embodiments, it should be readily understood that the invention is not limited to such disclosed embodiments. Rather, the invention can be modified to incorporate any number of variations, alterations, substitutions or equivalent arrangements not heretofore described, but which are commensurate with the spirit and scope of the invention. Additionally, while various embodiments of the invention have been described, it is to be understood that aspects of the invention may include only some of the described embodiments. Accordingly, the invention is not to be seen as limited by the foregoing description, but is only limited by the scope of the appended claims.

What is claimed is:

1. A battery pack comprising:
a pack casing having a vent side wall, and a closed side wall ;
a plurality of battery subpacks disposed in the pack casing, each battery subpack of the plurality of battery subpacks including an enclosure including:
a vent end proximate the vent side wall of the pack casing, wherein the vent end includes a subpack vent that opens when pressure within the enclosure of the battery subpack exceeds the threshold pressure; and
a connector end proximate the closed side wall of the pack casing, wherein the connector end includes an electrical terminal; and
a pack vent manifold defined between the vent side wall of the pack casing and the vent ends of the plurality of battery subpacks, wherein the pack vent manifold is in fluid communication with a pack exhaust outlet extending through the pack casing.

2. The battery pack of claim 1, further comprising an explosive fire zone (EFZ) defined by at least the pack exhaust outlet and the pack vent manifold, wherein the EFZ directs ejecta from a battery subpack of the plurality of battery subpacks away from the connector end, through the pack vent manifold, and out of the battery pack through the pack exhaust outlet.

3. The battery pack of claim 2, wherein the EFZ further includes the vent ends of the battery subpacks.

4. The battery pack of claim 3, wherein the EFZ further includes interiors of the battery subpack.

5. The battery pack of claim 1, wherein the pack exhaust outlet is in fluid communication with an exterior of an electric vehicle in which the battery pack is installed.

6. The battery pack of claim 1, wherein the pack exhaust outlet is configured for fluid communication with an exhaust outlet of an electric vehicle when the battery pack is installed therein.

7. A battery pack comprising:
a pack casing having a vent side wall and a closed side wall;
a plurality of battery subpacks disposed in the pack casing, each including:
a vent end proximate the vent side wall of the pack casing, wherein the vent end includes a fluid connector; and
a connector end proximate the closed side wall of the pack casing, wherein the connector end includes an electrical terminal;
a pack vent manifold defined between the vent side wall of the pack casing and the vent ends of the plurality of battery subpacks, wherein the pack vent manifold is in fluid communication with a pack exhaust outlet formed in and through the pack casing;
a pack fluid connector at least partially within a wall of the pack casing; and
a fluid conduit in the pack vent manifold that is in fluid communication with the pack fluid connector and the fluid connector of one of the battery subpacks.

8. The battery pack of claim 7, wherein the pack fluid connector is configured for fluid communication with one of a vehicle fluid connection port or a fluid connector of another, substantially identical battery pack.

9. The battery pack of claim 7, wherein the pack fluid connector is in parallel fluid communication with a respective fluid connector of each battery subpack of the plurality of battery subpacks via respective fluid conduits in the pack vent manifold.

10. The battery pack of claim 7, wherein for each battery subpack of the plurality of battery subpacks, the respective fluid connector is a first fluid connector and each battery subpack further includes a second fluid connector, the pack fluid connector is in fluid communication with the first fluid connector of a first battery subpack of the plurality of battery subpacks via a respective fluid conduit.

11. The battery pack of claim 7, wherein the pack fluid connector is a first pack fluid connector, a second pack fluid connector extends through a second wall of the pack casing and is in fluid communication with a respective fluid connector of at least one battery subpack of the plurality of battery subpacks via a respective fluid conduit in the pack vent manifold.

12. The battery pack of claim 11, wherein for each battery subpack the respective fluid connector is a first fluid connector and each battery subpack further includes a second fluid connector, the first pack fluid connector is in parallel fluid communication with the first fluid connector of each battery subpack of the plurality of battery subpacks via respective fluid conduits in the pack vent manifold, and the second pack fluid connector is in parallel fluid communication with the second fluid connector of each battery subpack of the plurality of battery subpacks.

13. The battery pack of claim 11, wherein for each battery subpack of the plurality of battery subpacks the respective fluid connector is a first fluid connector and each battery subpack further includes a second fluid connector, the first pack fluid connector is in fluid communication with the first fluid connector of a first battery subpack of the plurality of battery subpacks via the respective fluid conduit, the second pack fluid connector is in fluid communication with the second fluid connector of a last battery subpack of the plurality of battery subpacks, and additional fluid conduits in the pack vent manifold fluidly connect the fluid connectors of the plurality of battery subpacks in series starting with the second fluid connector of the first battery subpack and ending with the first fluid connector of the last battery subpack.

14. The battery pack of claim 11, wherein the second pack fluid connector is configured for fluid communication with one of a vehicle fluid connection port or a first pack fluid connector of another, substantially identical battery pack.

15. A battery pack comprising:
a pack casing having a vent side wall, and a closed side;
a plurality of battery subpacks disposed in the pack casing, each battery subpack of the plurality of battery subpacks including an enclosure including:
a vent end proximate the vent side wall of the pack casing, wherein the vent end includes a fluid connector and a vent configured to open when pressure within the enclosure of the battery subpack exceeds a threshold pressure; and
a connector end proximate the closed side wall of the pack casing, wherein the connector end includes an electrical terminal;
a pack vent manifold defined between the vent side wall of the pack casing and the vent ends of the plurality of battery subpacks, wherein the pack vent manifold is in fluid communication with a pack exhaust outlet within the pack casing and;
a fluid conduit in the pack vent manifold that extends from a pack fluid connector to a fluid connector of at least one battery subpack of the plurality of battery subpacks.

16. The battery pack of claim 15, further comprising an explosive fire zone (EFZ) defined by at least the pack exhaust outlet and the pack vent manifold, wherein the EFZ directs ejecta from a battery subpack of the plurality of battery subpacks away from the connector end, through the pack vent manifold, and out of the battery pack through the pack exhaust outlet.

17. The battery pack of claim 16, wherein the EFZ further includes the vent ends of the battery subpacks.

18. The battery pack of claim 15, wherein the pack fluid connector is a first pack fluid connector, the fluid connector of each battery subpack is a respective first fluid connector in parallel fluid communication with the first pack fluid connector via a respective fluid conduit in the pack vent manifold, and each battery subpack includes a second fluid connector in parallel fluid communication with a second pack fluid connector via additional fluid conduits in the pack vent manifold.

19. The battery pack of claim 15, wherein the pack fluid connector is a first pack fluid connector, the fluid connector of each battery subpack is a respective first fluid connector, the first pack fluid connector is in fluid communication with the first fluid connector of a first battery subpack via a respective fluid conduit in the pack vent manifold, each battery subpack includes a second fluid connector, the fluid connectors of the battery subpacks are fluidly connected in series via additional fluid conduits in the pack vent manifold beginning with the second fluid connector of the first battery subpack and ending with the first fluid connector of a last battery subpack.

20. The battery subpack of claim 19, wherein the second fluid connector of the last battery subpack is in fluid communication with a second pack fluid connector via a respective fluid conduit in the pack vent manifold.
